(19) United States
(12) Patent Application Publication
(10) Pub. No.: US 2009/0061902 A1
(43) Pub. Date: Mar. 5, 2009

(54) Directories and groupings in a geo-spatial environment

(75) Inventor: Raj Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/899,423

(22) Filed: Sep. 5, 2007

(51) Int. Cl. H04Q 7/20

(52) U.S. Cl. 455/456.3

(57) ABSTRACT

A method, apparatus and system of directories and groupings in a geo-spatial environment are disclosed. In one embodiment, a method includes automatically placing communication information associated with a set of neighbors in a geo-spatial area into a group, mapping the set of neighbors in a map that simultaneously renders a set of pushpins representing each location of the set of neighbors to each other, and enabling a moderator and users of the group to provide additional information on each of the set of neighbors such that data associated with the set of neighbors is accessible by those of the set of neighbors who subscribe to the group. The method may further include providing a multi-modal interface such that the communication information enables communication through a plurality of modes including phone, fax, SMS, email, printed mail, and/or face to face meetings between the set of neighbors.

### FIELD OF TECHNOLOGY

This disclosure relates generally to the technical fields of communications and, in one example embodiment, to a method, apparatus, and system of directories and groupings in a geo-spatial environment.

### BACKGROUND

A directory (e.g., a school directory, a service club directory, a church directory, etc.) may be distributed to members of a group (e.g., a group of parents, members of a community group, etc.) in printed form (e.g., a pamphlet, a booklet, a paper, etc.). The directory may include addresses, phone numbers and/or electronic contact information of the members of the group. Members of the group may trust each other for recommendations, advice, and tips because of a shared association with a physical place (e.g., a school, a church, etc.). Members of the group may wish to meet with each other on occasion to carpool (and/or walk) to a central meeting place (e.g., a school, a church, etc.). However, members represented in the directory may not know how close other members are from each other. In addition, members of the group may not receive communications and/or tips from other members of the group.

### SUMMARY

A method, apparatus and system of directories and groupings in a geo-spatial environment are disclosed. In one aspect, a method includes automatically placing communication information associated with a set of neighbors in a geo-spatial area into a group, mapping the set of neighbors in a geo-spatial map that simultaneously renders a set of pushpins representing each location of the set of neighbors to each other, and enabling a moderator and users of the group to provide additional information on each of the set of neighbors such that data associated with the set of neighbors is accessible by those of the set of neighbors who subscribe to the group.

In addition, the method may include providing a multi-modal interface such that the communication information enables communication through a plurality of modes including phone, fax, SMS, email, printed mail, and/or face to face meetings between the set of neighbors. The method may also include aggregating a geo-spatial group index having the group and other groups acquired through a set of internet portals when the moderator ports the other groups through the internet portals into a geo-spatial social network. The data includes a visual representation of the set of pushpins simultaneously displayed in the geo-spatial map. Each of the set of pushpins is tied to a set of multi-modal contact information provided through users and the moderator.

The method may also include providing an interface such that the moderator is able to limit access and/or editability of the multi-modal contact information. The multi-modal contact information may be integrated into the geo-spatial social network through a printed directory (e.g., may include a school directory, a church directory, a service club directory, a student directory, a block watch directory and/or a neighborhood directory, etc.) automatically transferred into the group.

In another aspect, a method of performing a search includes obtaining a keyword from a member of a community network, obtaining a location associated with the member, obtaining a plurality of profiles in the community network corresponding to the keyword and the location, and displaying the plurality of profiles on a geo-spatial map. In addition, the method may include obtaining a search radius from the member, and adjusting the profiles using the search radius. The method may also include obtaining a group name from the member, creating a group using the group name, and associating the profiles with the group.

The method may further include displaying the group on the geo-spatial map. The method may also include displaying a mass profile edit option associated with the profiles to the member. Each of the profiles may be any one of a claimed profile and an unclaimed profile. In addition, each of the profiles may be associated with a person, a business, and/or an organization, etc.

In yet another aspect, a community network includes a member repository including a plurality of members, a geo-spatial repository including a plurality of locations on a geo-spatial map, a member management module configured to obtain member data (e.g., may include one of the locations) associated with each of the members, and a member recommendation module configured to obtain a keyword and a location from one of the members, obtain a subset of profiles corresponding to the keyword and the location, and display the subset of the profiles on the geo-spatial map. The member recommendation module may further be configured to obtain a search radius from the one of the members, and adjust the subset of the profiles using the search radius.

The community network may also include a group management module configured to obtain a group name from the one of the members, create a group using the group name, and associate the subset of the profiles with the group. The group management module may be configured to display the group on the geo-spatial map. The member recommendation module may also be configured to display a mass profile edit option associated with the subset of the profiles to the one of the members. Each of the profiles may be any one of a claimed profile and an unclaimed profile. In addition, the profiles may be associated with a person, a business, and/or an organization.

In a further aspect, a method of managing a community network includes obtaining member data associated with a member of the community network, determining a location of the member based on the member data, storing the member data in a member repository, obtaining a plurality of profiles based on the member data and the location, and recommending the profiles to the member.

In addition, the method may include displaying the profiles on a geo-spatial map. The method may further include obtaining a login and password associated with a group from the member, and importing the group (e.g., may be provided using an external service) using the login and password. Each of the profiles may be any one of a claimed profile and an unclaimed profile.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a community network enabling recommendations and groupings in a geo-spatial environment, according to one embodiment.

FIG. 2A is a user interface view of obtaining search parameters from a member of the community network, according to one embodiment.

FIG. 2B is a user interface view displaying profiles corresponding to the search parameters (e.g., keyword and search radius) specified by the member, according to one embodiment.

FIG. 2C is a user interface view of obtaining a group name from the member, according to one embodiment.

FIG. 2D is a user interface view displaying the members of the group on the geo-spatial map, according to one embodiment.

FIG. 3 is a user interface view displaying recommended profiles and importing groups through external services, according to one embodiment.

FIG. 4 is a block diagram representation illustrating information associated with a profile, according to one embodiment.

FIG. 5 is a flow chart to recommend profiles and import group(s) using login information, according to one embodiment.

FIG. 6 is a flow chart to display a group formed using profiles by the member of the community network on a geo-spatial map, according to one embodiment.

FIG. 7 is a flowchart to view groups on the geo-spatial map, according to one embodiment.

FIG. 8 is a diagrammatic system view of a data processing system in which any of the embodiments disclosed herein may be performed, according to one embodiment.

FIG. 9 is a process flow of providing communication information and aggregating a geospatial group index, according to one embodiment.

FIG. 10A is a process flow of performing a search of user profiles and creating a group using the user profiles, according to one embodiment.

FIG. 10B is a continuation of the process flow of FIG. 10A, illustrating additional process, according to one embodiment.

FIG. 11 is a process flow of displaying profiles and importing groups, according to one embodiment.

Other features of the present embodiments will be apparent from the accompanying drawings and from the detailed description that follows.

### DETAILED DESCRIPTION

A method, apparatus and system of directories and groupings in a geo-spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

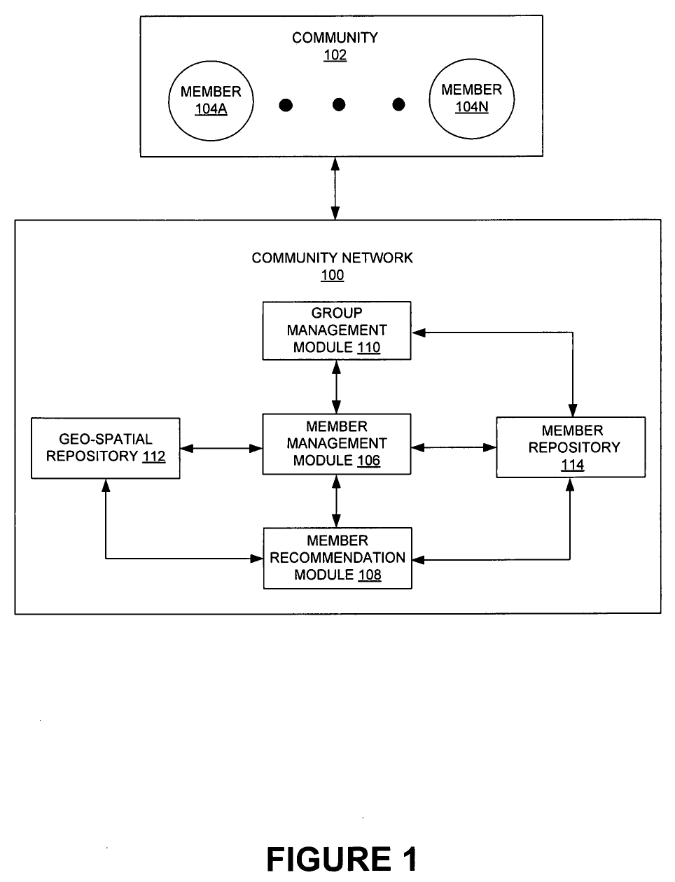

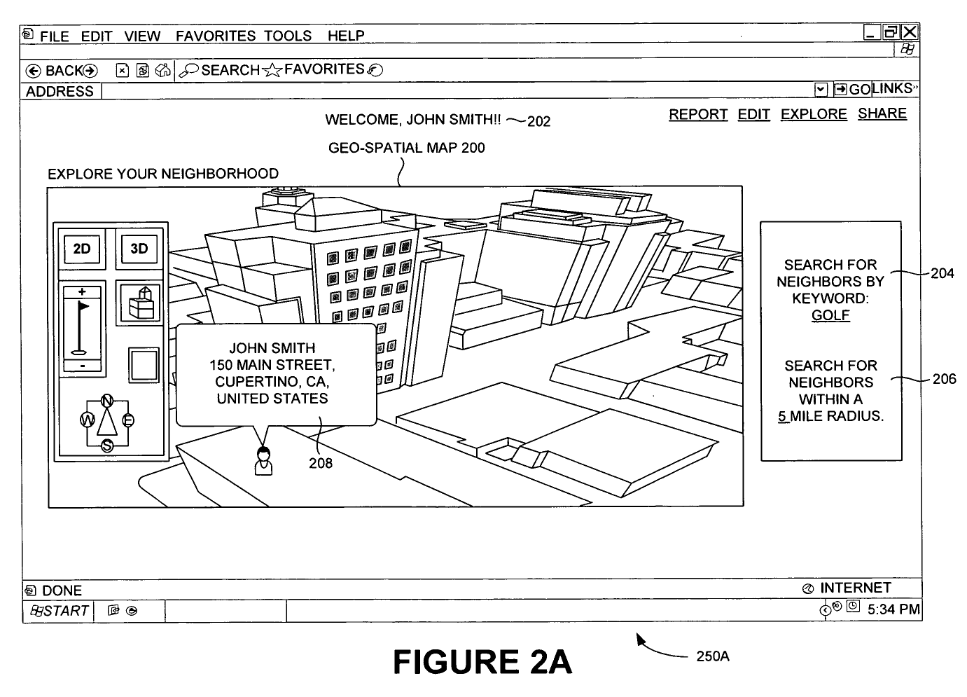

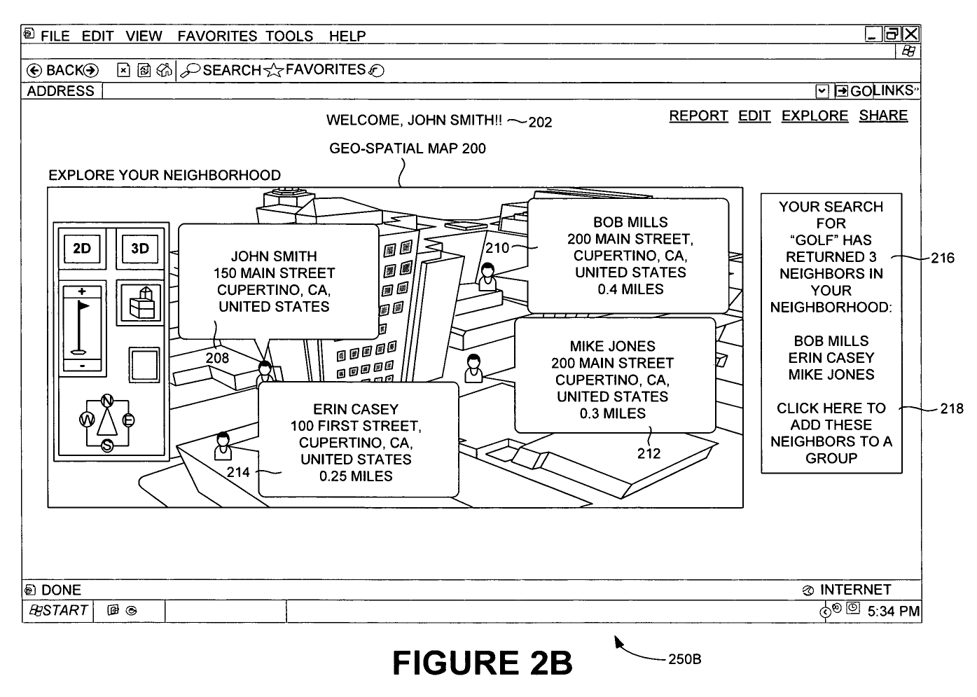

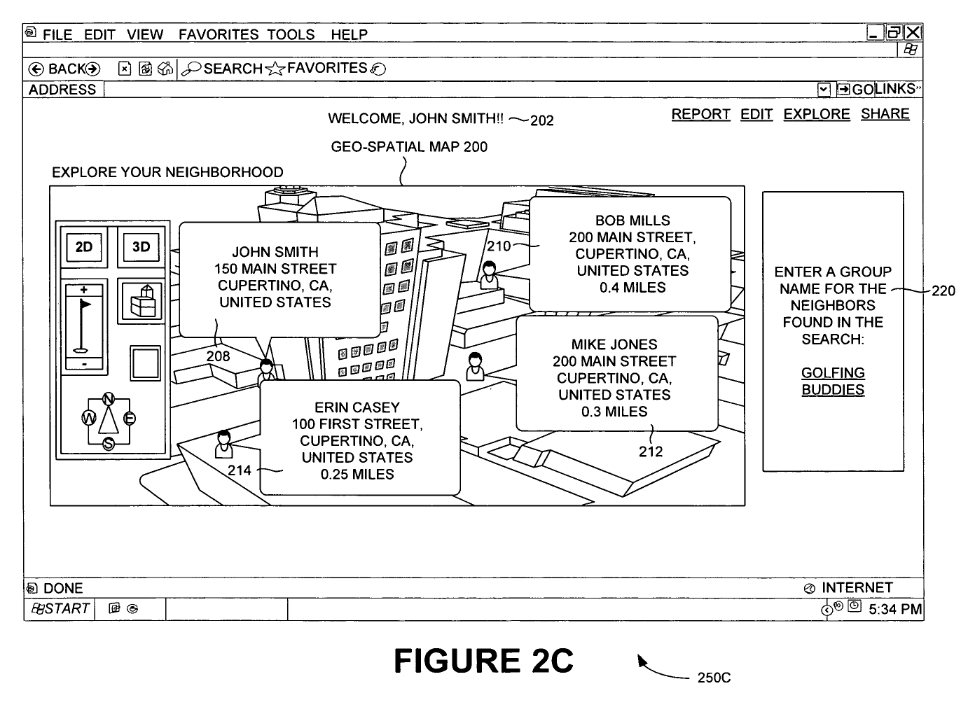

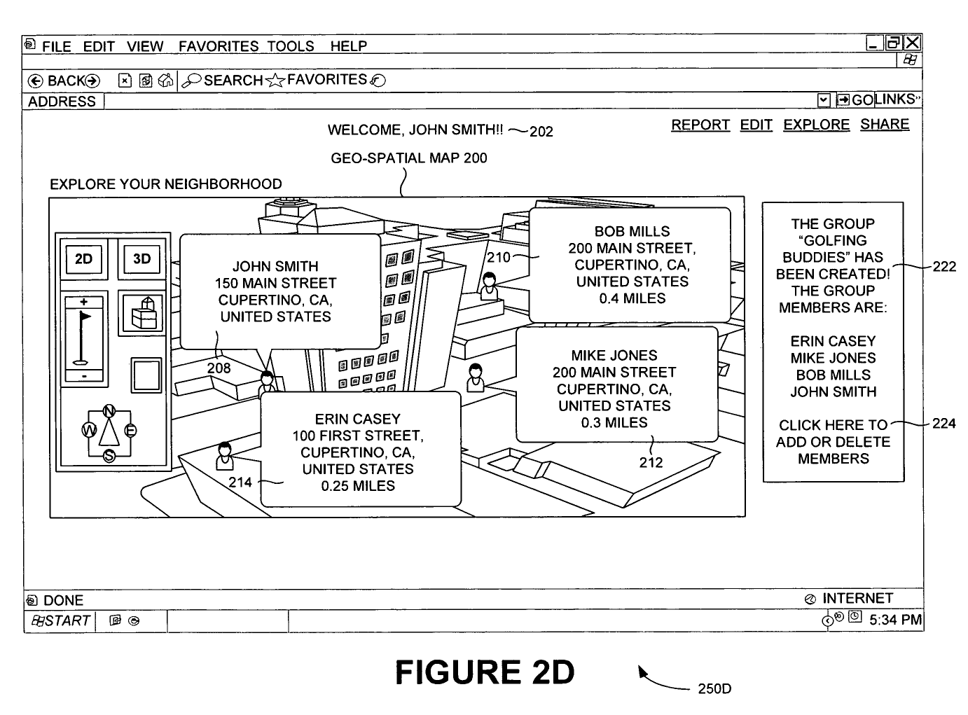

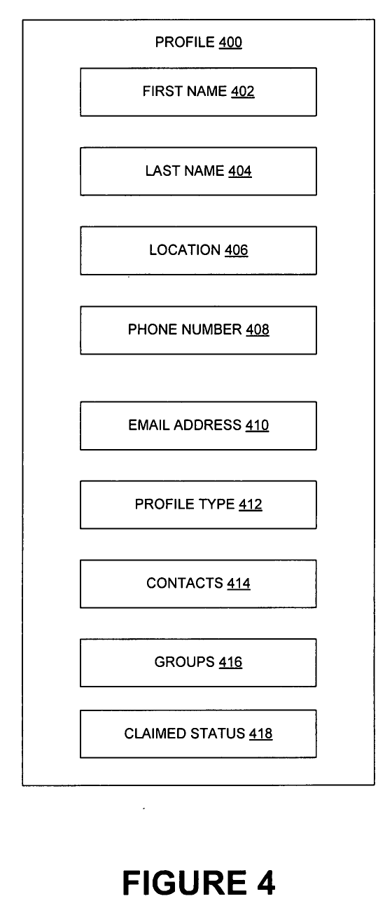

In one embodiment, a method includes automatically placing communication information associated with a set of neighbors (e.g., members of a community network and/or neighborhood, etc.) in a geo-spatial area (e.g., a 3D visualization of the neighborhood) into a group (e.g., the groups 416 illustrated in FIG. 4), mapping the set of neighbors in a geo-spatial map (e.g., the geo-spatial map 200 of FIG. 2) that simultaneously renders a set of pushpins representing each location of the set of neighbors to each other (e.g., markers on the geo-spatial map 200), and enabling a moderator and users of the group to provide additional information on each of the set of neighbors such that data associated with the set of neighbors is accessible by those of the set of neighbors who subscribe to the group (e.g., using the group management module 110 of FIG. 1).

In another embodiment, a method of performing a search includes obtaining a keyword from a member (e.g., the members 104A-N of FIG. 1) of a community network (e.g., the community network 100 of FIG. 1), obtaining a location associated with the member 104, obtaining profiles (e.g., the profiles 208, 210, 212 and 214 of FIGS. 2B, 2C and 2D) in the community network 100 corresponding to the keyword and the location, and displaying the profiles 208, 210, 212 and 214 on a geo-spatial map (e.g., the geo-spatial map 200 of FIGS. 2A, 2B, 2C, and 2D).

In yet another embodiment, a community network (e.g., the community network 100 of FIG. 1) includes a member repository (e.g., the member repository 114 of FIG. 1) including a number of members (e.g., the members 104A-N of FIG. 1), a geo-spatial repository (e.g., the geo-spatial repository 112 of FIG. 1) including a number of locations on a geo-spatial map (e.g., the geo-spatial map 200 of FIGS. 2A, 2B, 2C, and 2D), a member management module (e.g., the member management module 106 of FIG. 1) configured to obtain member data (e.g., may include one of the locations) associated with each of the members 104A-N, and a member recommendation module (e.g., the member recommendation module 108 of FIG. 1) configured to obtain a keyword and a location from a member 104 (e.g., of the members 104A-N), obtain a subset of profiles corresponding to the keyword and the location, and display the subset of the profiles on the geo-spatial map 200.

In a further embodiment, a method of managing a community network (e.g., the community network 100 of FIG. 1) includes obtaining member data associated with a member (e.g., of the members 104A-N of FIG. 1) of the community network 100, determining a location of the member 104 based on the member data, storing the member data in a member repository (e.g., the member repository 114 of FIG. 1), obtaining profiles (e.g., the profiles 208, 210, 212 and 214 of FIGS. 2B, 2C, and 2D) based on the member data and the location, and recommending the profiles 208, 210, 212 and 214 to the member 104.

FIG. 1 is a system view of a community network 100 enabling recommendations and groupings in a geo-spatial environment, according to one embodiment. Particularly, FIG. 1 illustrates the community network 100, a community 102, members 104A-N, a member management module 106, a member recommendation module 108, a group management module 110, a geo-spatial repository 112 and a member repository 114, according to one embodiment.

The community network 100 may be a network formed by association of the members 104A-N having user profiles in the community 102. The user profiles may include information such as names, addresses, contact information (e.g., phone numbers, email addresses, etc.), pictures, and/or other personal information. The community 102 may be a group of members 104A-N residing in a specific region. For example, the specific region may be a local neighborhood, a suburb, a village, a city, a county, a state, a nation, and/or a group of nations, etc.

The members 104A-N may include persons, businesses and/or organizations associated with specific geographic locations in the community 102. In an alternate embodiment, the members 104A-N may reside in multiple regions (e.g., multiple cities, states, countries, etc.). The members 104A-N may be connected through the community network 100 (e.g., accessible through a network connection such as the internet, a telecommunication network, etc.). The member management module 106 may obtain member data associated with the members 104A-N of the community 102. For example, the member data may include names, ages, professions, locations and/or address data associated with the members 104A-N. The member data may be displayed in the user profiles of the members 104A-N.

The member recommendation module 108 may obtain a keyword from the members 104A-N. The member recommendation module 108 may also obtain a location associated with the members 104A-N. The member recommendation module 108 may then obtain a group of members 104A-N corresponding to the keyword and the location. In one embodiment, the group of members 104A-N may be displayed on a geo-spatial map (e.g., the geo-spatial map 200 of FIGS. 2A, 2B, 2C and 2D).

In addition, the member recommendation module 108 may be configured to obtain a search radius from the members 104A-N, and to adjust the group of members 104A-N using the search radius. Further, the member recommendation module 108 may be configured to display a mass profile edit option associated with the group of members 104A-N to the members 104A-N. The member recommendation module 108 may also be configured to recommend other users to the member 104 of the community network 100.

The group management module 110 may obtain a group name from a member 104. In one embodiment, a group may be created using the group name. Further, the group management module 110 may associate the profiles of members 104A-N with the group. In another embodiment, the group may be displayed on the geo-spatial map 200.

The geo-spatial repository 112 may be a database containing location information of the members 104A-N. For example, locations associated with the members 104A-N may be obtained based on the member data stored in the member repository 114. The member repository 114 may be a database containing member data associated with the members 104A-N of the community 102.

In one embodiment, communication information associated with a set of neighbors may be automatically placed in a geo-spatial area into a group. The set of neighbors may be mapped in the geo-spatial map 200 that simultaneously renders a set of pushpins representing each location of the set of neighbors to each other.

In another embodiment, a moderator and users of the group may be enabled to provide additional information on each of the set of neighbors such that data associated with the set of neighbors is accessible by those of the set of neighbors who subscribe to the group. For example, the data may include a visual representation of the set of pushpins (e.g., each of the set of pushpins may be tied to a set of multi-modal contact information provided through the users and the moderator) simultaneously displayed in the geo-spatial map 200.

A multi-modal interface may be provided such that the communication information enables communication through a number of modes including phone, fax, SMS, email, printed mail, and/or face to face meetings between the set of neighbors. A geo-spatial group index having the group and other groups acquired through a set of internet portals may be aggregated when the moderator ports the other groups through the internet portals into a geo-spatial social network (e.g., the community network 100 of FIG. 1).

An interface may be provided such that the moderator is able to limit access and editability of the multi-modal contact information. In one example embodiment, the multi-modal contact information may be integrated into the geo-spatial social network through a printed directory (e.g., a school directory, a church directory, a service club directory, a student directory, a block watch directory and/or a neighborhood directory, etc.) automatically transferred into the group.

The member repository 114 may include a number of members 104A-N and the geo-spatial repository 112 may include a number of locations on the geo-spatial map 200. The member management module 106 may be configured to obtain member data (e.g., may include a location) associated with each of the members 104A-N. The member recommendation module 108 may be configured to obtain a keyword from a member (e.g., of the members 104A-N). In one embodiment, a subset of profiles may be obtained corresponding to the keyword and the location. In another embodiment, the subset of the profiles may be displayed on the geo-spatial map 200.

Further, the member recommendation module 108 may be configured to obtain a search radius (e.g., 5 miles) from the member 104, and adjust the subset of the profiles using the search radius. In one embodiment, the member recommendation module 108 may be configured to display a mass profile edit option associated with the subset of the profiles to the member 104. The group management module 110 may be configured to obtain a group name from the member 104, create a group using the group name, and associate the subset of profiles with the group. In one embodiment, the group may be displayed on the geo-spatial map 200.

FIG. 2A is a user interface view 250A of obtaining search parameters from a member (e.g., of the members 104A-N of FIG. 1) of the community network 100, according to one embodiment. Particularly, FIG. 2A illustrates a geo-spatial map 200, a welcome message 202, a search by keyword option 204, a search by radius option 206 and a profile block 208, according to one embodiment.

The geo-spatial map 200 may graphically display contact information (e.g., name and/or address) associated with the member 104 (e.g., owner of the webpage). For example, the contact information associated with the members 104A-N may be displayed through pushpins representing locations on the geo-spatial map 200. The welcome message 202 may display a unique identifier (e.g., first name, last name, user name, code, etc.) of the member 104 associated with the webpage. For example, the welcome message 202 may be displayed to the member 104 upon logging into the webpage. In one example embodiment, the webpage may be part of an internet portal that enables communication between the members in the geo-spatial social network (e.g., the community network 100 of FIG. 1).

The search by keyword option 204 may enable the member 104 of the community network 100 to search for profiles (e.g., claimed profiles and/or unclaimed profiles) associated with the neighbors by providing a search keyword as input. For example, the search keyword may include location information, occupation, hobbies, favorite dish and/or interests, etc., displayed in the profiles associated with the neighbors.

The search by radius option 206 may enable the member 104 of the community network 100 to search for the profiles associated with the neighbors within a specified radius. The profiles may be associated with persons, business and/or organizations. In one example embodiment, the search radius may be associated with a location obtained from the member 104. The profile block 208 may display contact information (e.g., name, city, state, country, etc.) of the member 104.

In the example embodiment illustrated in FIG. 2A, the user interface view 250A displays a neighborhood visualizing contact information associated with the member 104. The user interface view 250A also displays the welcome message 202 associated with the member 104. The welcome message 202 displays “Welcome, John Smith” representing a webpage associated with the member “John Smith”. The profile block 208 displays a name “John Smith” and address “150 Main Street, Cupertino, Calif., United States” associated with John Smith.

According to the example embodiment illustrated in FIG. 2A, John Smith may search for neighbors by entering the keyword “Golf” as search parameter through the search by keyword option 204. Further, John Smith may search for the profiles associated with the neighbors within a specified radius using the search by radius option 206. In the example embodiment illustrated in FIG. 2A, John Smith has entered the search radius as 5 miles, indicating that John Smith is looking for the neighbors interested in golf who are located within a 5-mile radius of 150 Main Street, Cupertino, Calif., United States.

A keyword may be obtained from a member 104 of a community network 100 (e.g., through the search by keyword option 204 of FIG. 2A). A location associated with the member 104 may also be obtained. In addition, a search radius may be obtained from the member 104 (e.g., through the search by radius option 206 of FIG. 2A).

FIG. 2B is a user interface view 250B displaying profiles corresponding to the search parameters (e.g., keyword and search radius) specified by the member 104, according to one embodiment. Particularly, FIG. 2B illustrates the geo-spatial map 200, the welcome message 202, profile blocks 208, 210, 212 and 214, an information block 216 and a click option 218, according to one embodiment.

The profile blocks 208, 210, 212 and 214 may display contact information (e.g., name, city, state, country, etc.) associated with the member 104 and/or the neighbors obtained in the search result. In one example embodiment, the profile block 208 displays the contact information associated with the member and the profile blocks 210, 212 and 214 displays the contact information associated with the neighbors.

The information block 216 may display information representing names of the neighbors associated with profiles in the community network 100 obtained corresponding to the search conducted by the member 104. The click option 218 may enable the member 104 to add the neighbors obtained in the search to a group. In one example embodiment, the group may be created by the member 104 by making use of the profiles obtained in the search result.

In the example embodiment illustrated in FIG. 2B, the user interface view 250B displays the welcome message 202 and the profile blocks 208, 210, 212 and 214 on the geo-spatial map 200. The welcome message 202 displays “Welcome, John Smith” representing a webpage associated with the member “John Smith”. The profile block 208 displays the member “John Smith” and address “150 Main Street, Cupertino, Calif., United States” associated with John Smith. The profile block 210 displays neighbor “Bob Mills” whose address is “200 Main Street, Cupertino, Calif., United States” and radius “0.4 miles,” indicating that Bob Mills is located a distance of 0.4 miles from John Smith's location.

The profile block 212 displays another neighbor “Mike Jones” and address “200 Main Street, Cupertino, Calif., United States” and radius “0.3 miles” indicating that Mike Jones is located a distance of 0.3 miles from John Smith's location. Similarly, the profile block 214 displays yet another neighbor “Erin Casey” and address “100 First Street, Cupertino, Calif., United States” and radius “0.25 miles” indicating Erin Casey is located a distance of 0.25 miles from John Smith's location.

The information block 216 displays “Your search for ‘Golf’ has returned 3 neighbors in your neighborhood” indicating that 3 neighbors are located within the 5 miles radius who are associated with the search keyword “Golf”. The information block 216 also displays names of the neighbors: Bob Mills, Erin Casey and Mike Jones. John Smith may choose to add Bob Mills, Erin Casey and Mike Jones to a group.

For example, a number of profiles (e.g., claimed, unclaimed, etc.) may be obtained in the community network 100 corresponding to the keyword and the location. In one embodiment, the profiles (e.g., associated with a person, business, and/or organization, etc.) may be displayed on the geo-spatial map 200. The profiles may be adjusted using the search radius. For example, a mass profile edit option associated with the profiles may be displayed to the member 104.

FIG. 2C is a user interface view 250C of obtaining a group name from the member 104, according to one embodiment. Particularly, FIG. 2C illustrates the geo-spatial map 200, the welcome message 202, the profile blocks 208, 210, 212 and 214 and an enter a group name option 220, according to one embodiment.

The enter a group name option 220 may enable the member 104 of the community network 100 to specify a group name corresponding to the profiles (e.g., of the neighbors) obtained through the search. In one example embodiment, the member 104 may specify different group names corresponding to profiles obtained in different searches.

In the example embodiment illustrated in FIG. 2C, the user interface view 250C displays the welcome message 202 and the profile blocks 208, 210, 212 and 214 on the geo-spatial map 200. The welcome message 202 displays “Welcome, John Smith” representing a webpage associated with the member “John Smith”. John Smith may form a group by providing a group name, e.g., “Golfing Buddies” (e.g., having the neighbors obtained in the search), using the enter group name option 220. In addition, John Smith may associate the profiles of Bob Mills, Erin Casey and Mike Jones with the group under the group name.

FIG. 2D is a user interface view 250D displaying the members of the group on the geo-spatial map 200, according to one embodiment. Particularly, FIG. 2D illustrates the geo-spatial map 200, the welcome message 202, the profile blocks 208, 210, 212 and 214, a block 222 and a click option 224, according to one embodiment.

The block 222 displays information representing the group name and the members 104A-N associated with the group. The name of the group may be specified by the member 104. The click option 224 may enable the member 104 to add new members 104A-N to the group and/or delete the members from the group.

In the example embodiment illustrated in FIG. 2D, the user interface view 250D displays the welcome message 202 and the profile blocks 208, 210, 212 and 214 on the geo-spatial map 200. The block 222 displays information “the group ‘Golfing Buddies’ has been created” indicating that the Golfing Buddies group is created corresponding to the group name obtained (e.g., through the enter group name option 220 of FIG. 2C) from John Smith. The block 222 also displays the members of the group as Erin Casey, Mike Jones, Bob Mills and John Smith on the geo-spatial map 200. John Smith may further add or remove the members 104A-N from the group based on validity of the members 104A-N in the specified radius. For example, the group may be created using the group name (e.g., Golfing Buddies), and the profiles may be associated with the group. In another embodiment, the group may be displayed on the geo-spatial map 200.

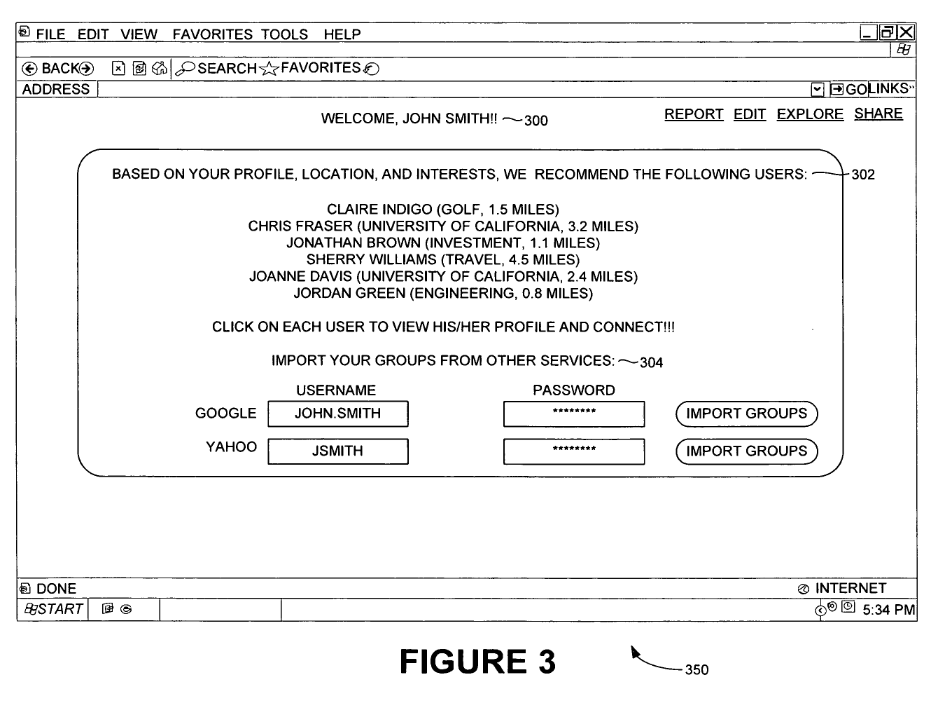

FIG. 3 is a user interface view 350 displaying recommended profiles and importing groups through external services (e.g., distribution lists, contact databases and/or directories, electronic address books, etc.), according to one embodiment. Particularly, FIG. 3 illustrates a welcome message 300, recommended profiles 302 and an option 304, according to one embodiment.

The welcome message 300 may display a unique identifier (e.g., first name, last name, code, etc.) of the member 104 associated with the webpage. The welcome message 300 may be displayed to the member 104 upon logging into the webpage 350. In one embodiment, the recommended profiles 302 may be profiles displayed to the member 104 that are obtained based on the member data. For example, the profiles may be displayed based on a keyword and search radius. The option 304 may enable importing of groups associated with the member 104 from external services.

In the example embodiment illustrated in FIG. 3, the user interface view 350 displays the profiles recommended to the member 104 (e.g., John Smith) associated with the community network 100. The user interface view 350 displays the keywords associated with member data of John Smith as golf, University of California, investment, travel, engineering, etc. based on which the profiles are recommended. John Smith may click on each of the profiles to view and be connected to the recommended profiles. In addition, John Smith may enter logins and passwords corresponding to various external services to import associated groups using the option 304.

In one embodiment, member data associated with a member (e.g., of the members 104A-N) of the community network 100 may be obtained. A location of the member 104 may be determined based on the member data. The member data may be stored in a member repository 116. A number of profiles (e.g., a claimed profile, an unclaimed profile, etc.) may be obtained based on the member data and the location. For example, the profiles may be recommended to the member 104 and/or displayed on the geo-spatial map 200. A login and password associated with a group (e.g., provided using an external service) may be obtained from the member 104 and the group may be imported using the login and password.

FIG. 4 is a block diagram representation illustrating information associated with a profile 400, according to one embodiment. Particularly, FIG. 4 illustrates a first name block 402, a last name block 404, a location block 406, a phone number block 408, an email address block 410, a profile type block 412, contacts block 414, groups block 416 and a claimed status block 418, according to one embodiment.

The block diagram may display a first name of a member 104 in the first name block 402, a last name of the member 104 in the last name block 404, a location information in the location block 406, a phone number in the phone number block 408, an email address associated with the member 104 in the email address block 410. For example, the member 104 may be an individual having a profile (e.g., a claimed or unclaimed profile) and may have formed or joined a group in a geo-spatial social network.

The profile type block 412 may display details associated with type of the profile (e.g., a person, a business, and/or an organization, etc.). The contacts block 414 may display a list of other users to which the member 104 of the group is connected. The groups block 416 may display a geo-spatial group index indicating groups formed or joined by the member 104. In one embodiment, the groups may be provided using an external service. The claimed status block 418 may indicate whether the member 104 of the group has claimed his/her profile or not.

In the example embodiment illustrated in FIG. 4, the block diagram representation displays profile information associated with member 104 who has subscribed to the group in the geo-spatial social network. For example, the profile information may include first name, last name, location, phone number, email address, profile type, contacts, and/or groups, etc.

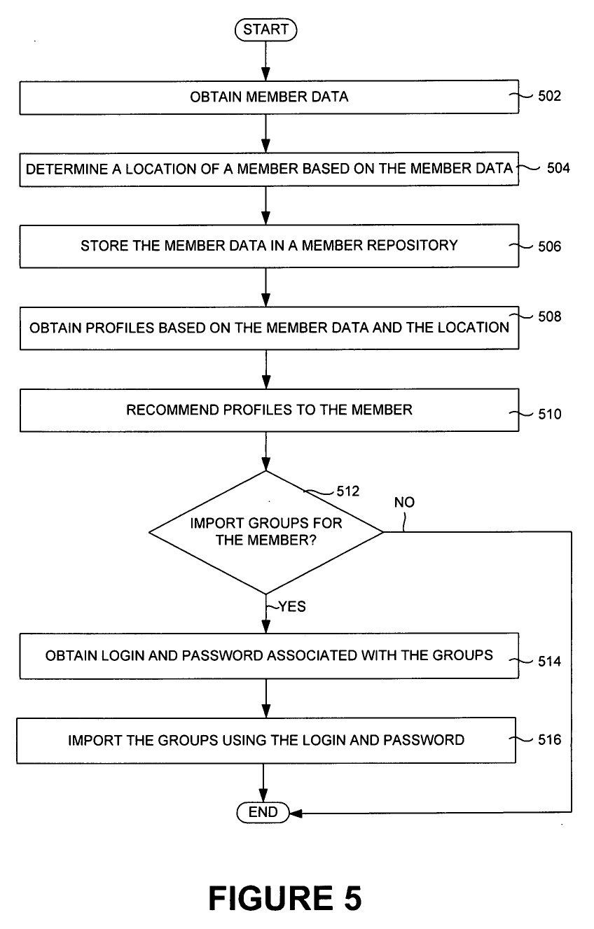

FIG. 5 is a flow chart to recommend profiles and import group(s) using login information, according to one embodiment. In operation 502, member data is obtained (e.g., using the member management module 106 of FIG. 1). For example, the member data may include age, gender, profession, interests, address data, and/or group affiliation, etc. In operation 504, a location of a member 104 is determined based on the member data. For example, a particular location associated with the member 104 may be identified on a geo-spatial map 200 using the member data.

In operation 506, the member data is stored in the member repository 114. In operation 508, the profiles (e.g., profiles of users in a neighborhood) are obtained based on the member data and the location. In one embodiment, the profiles associated with the location may be obtained within a search radius (e.g., specified by the user). In another embodiment, the profiles may be obtained based on a search query provided by the user.

In operation 510, the profiles are recommended (e.g., using the member recommendation module 108 of FIG. 1) to the member 104. In one embodiment, the profiles may be recommended to the member 104 based on the member data such as interests, location, group affiliation, etc. and a search radius. The member 104 may connect with the recommended profiles based on member data associated with the profiles.

In operation 512, it is determined whether any groups associated with the member 104 are to be imported from an external services or not. If the member wishes to import group(s) from the external services, then operation 514 is performed, else, the process may terminate. In operation 514, login information (e.g., email ID, screen name, username, password, and/or pin, etc.) associated with the groups is obtained. In operation 516, the groups associated with the member 104 are imported from the external services using the login information (e.g., provided by the member 104).

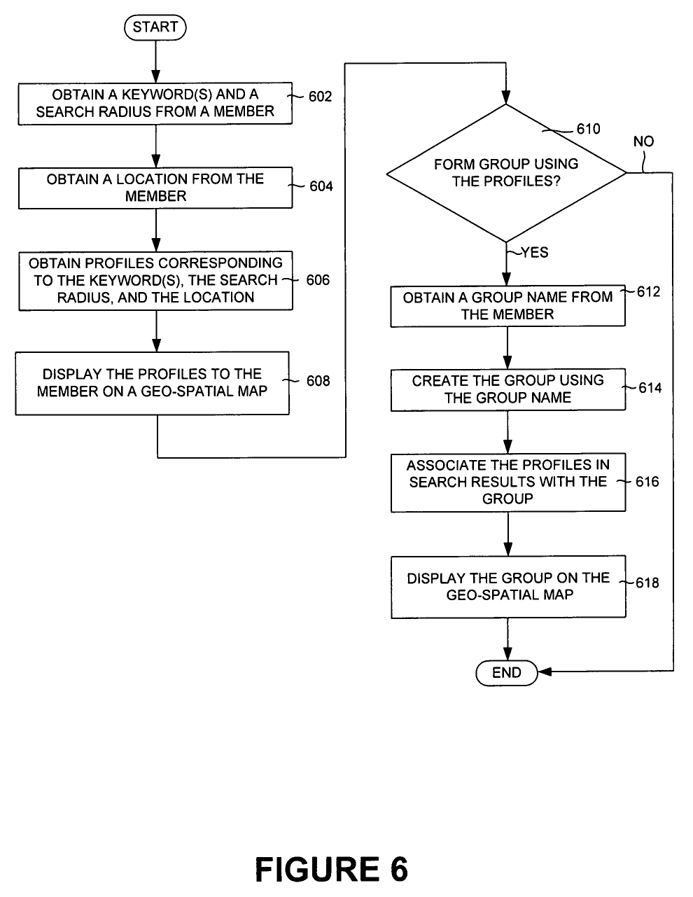

FIG. 6 is a flow chart to display a group formed using profiles by the member 104 of the community network 100 on the geo-spatial map 200, according to one embodiment. In operation 602, a keyword(s) and/or a search radius is obtained from a member 104 of the geo-spatial social network. For example, the keyword may include interest, group name, party name, university, field of profession, etc. In operation 604, a location is obtained from the member 104.

In operation 606, profiles corresponding to the keyword(s), the search radius and/or the location are obtained (e.g., using the member recommendation module 108 of FIG. 1). For example, the profiles may be associated with any one of a person, a business and an organization. In addition, the profiles may be any one of a claimed profile and unclaimed profile. In operation 608, the profiles may be displayed to the member 104 on the geo-spatial map 200. In one embodiment, the profiles may be represented through a set of pushpins on the geo-spatial map 200.

In operation 610, it is determined whether the member 104 wishes to form a group using the profiles or not. If the member 104 wants to form a group using the profiles, then operation 612 is performed, else, the process may terminate. In operation 612, a group name is obtained from the member 104 (e.g., in the event that the member 104 wants to form a group). In operation 614, the group is created using the group name (e.g., specified by the member 104). In operation 616, the profiles in the search results are associated with the group. In operation 618, the group formed by the member 104 of the geo-spatial social network is displayed on the geo-spatial map 200. In one embodiment, the group may be displayed in conjunction with other groups (e.g., acquired through a set of internet portals) on a geo-spatial map 200.

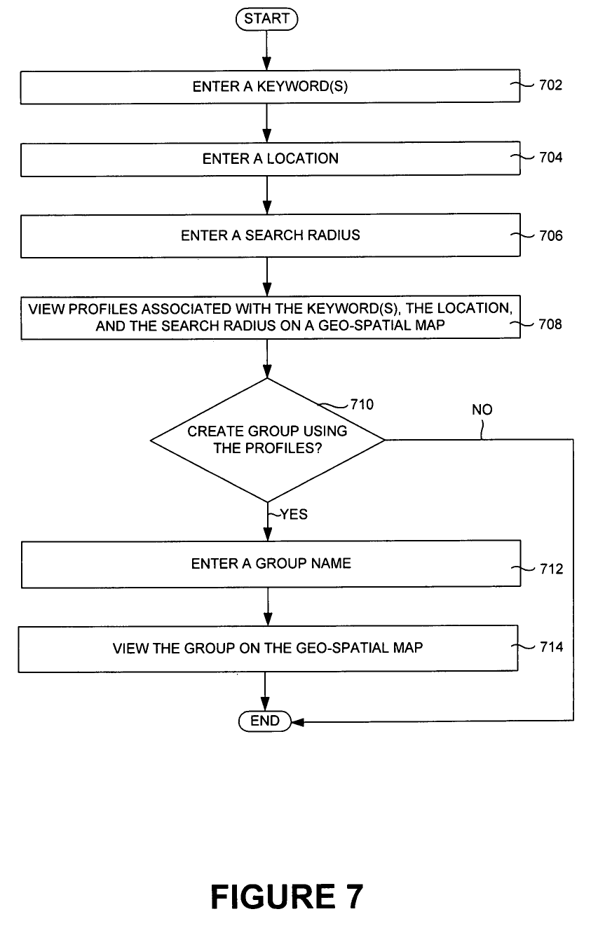

FIG. 7 is a flowchart to view groups on the geo-spatial map 200, according to one embodiment. In operation 702, a keyword(s) associated with a search is entered. In operation 704, a location corresponding to profiles is entered. In operation 706, a search radius corresponding to the location is entered. In operation 708, the profiles associated with the keyword(s), the location, and the search radius are viewed on the geo-spatial map 200. The profiles may be associated with any one of a personal, a business and an organization.

In operation 710, it is determined whether a group is to be created using the profiles (e.g., displayed corresponding to the search radius and the keyword(s) at the location) or not. If the group is to be created then operation 712 is performed, else the process may terminate. In operation 712, a group name corresponding to the group created by the member 104 is entered. In operation 714, the group formed using the profiles is viewed in conjunction with other groups on the geo-spatial map.

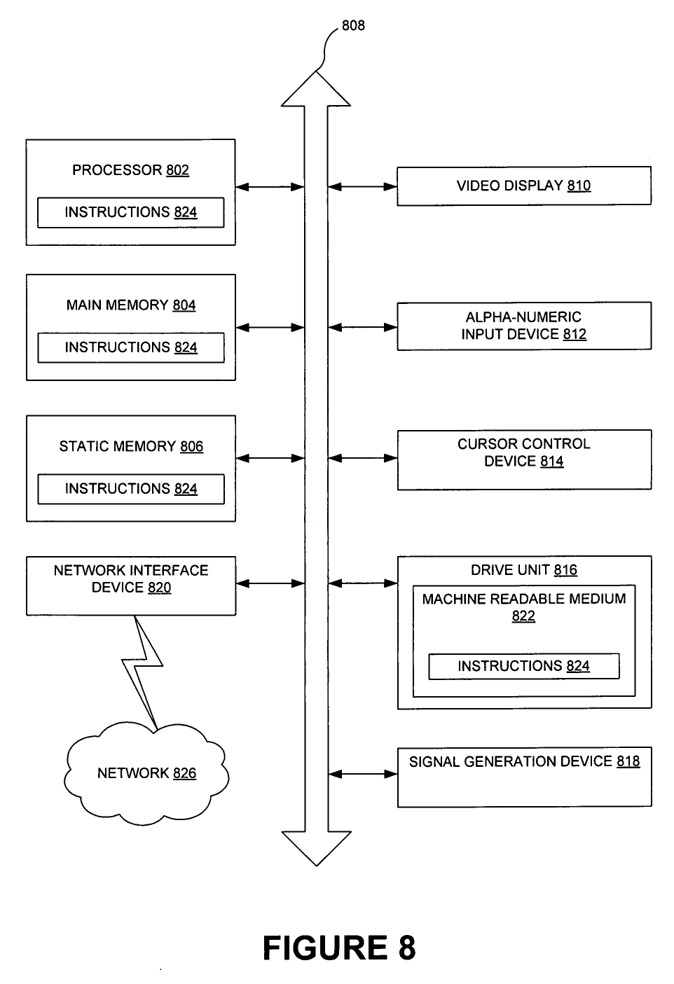

FIG. 8 is a diagrammatic system view 800 of a data processing system in which any of the embodiments disclosed herein may be performed, according to one embodiment. Particularly, the diagrammatic system view 800 of FIG. 8 illustrates a processor 802, a main memory 804, a static memory 806, a bus 808, a video display 810, an alpha-numeric input device 812, a cursor control device 814, a drive unit 816, a signal generation device 818, a network interface device 820, a machine readable medium 822, instructions 824 and a network 826, according to one embodiment.

The diagrammatic system view 800 may indicate a personal computer and/or a data processing system in which one or more operations disclosed herein are performed. The processor 802 may be microprocessor, a state machine, an application specific integrated circuit, a field programmable gate array, etc. The main memory 804 may be a dynamic random access memory and/or a primary memory of a computer system.

The static memory 806 may be a hard drive, a flash drive, and/or other memory information associated with the data processing system. The bus 808 may be an interconnection between various circuits and/or structures of the data processing system. The video display 810 may provide graphical representation of information on the data processing system. The alpha-numeric input device 812 may be a keypad, keyboard and/or any other input device of text (e.g., special device to aid the physically handicapped). The cursor control device 814 may be a pointing device such as a mouse.

The drive unit 816 may be the hard drive, a storage system, and/or other longer term storage subsystem. The signal generation device 818 may be a bios and/or a functional operating system of the data processing system. The network interface device 820 may be a device that may perform interface functions such as code conversion, protocol conversion and/or buffering required for communication to and from a network. The machine readable medium 822 may provide instructions on which any of the methods disclosed herein may be performed. The instructions 824 may provide source code and/or data code to the processor 802 to enable any one or more operations disclosed herein.

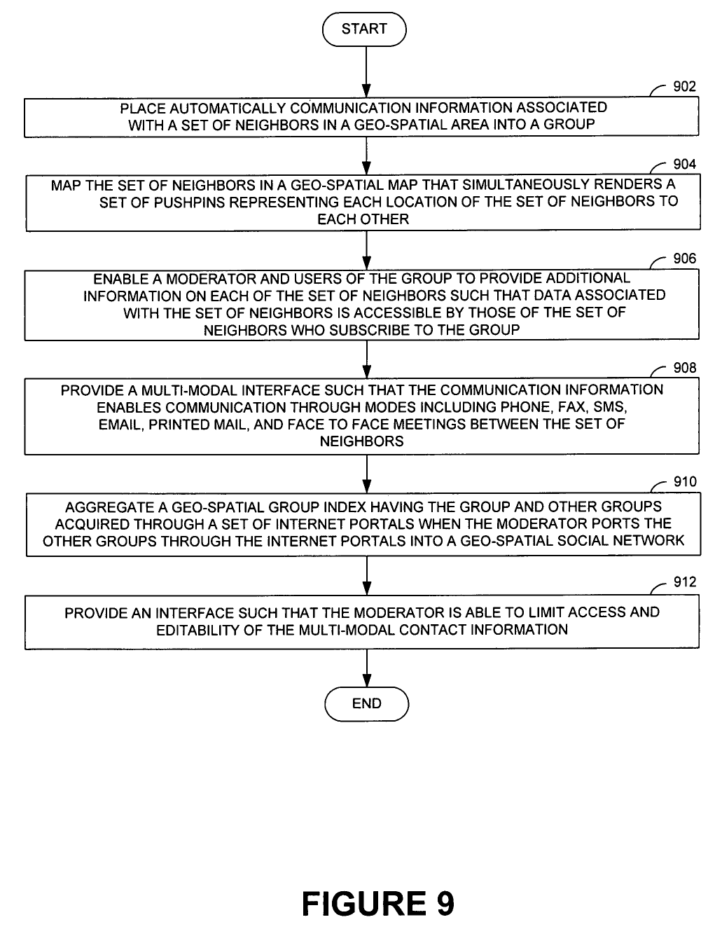

FIG. 9 is a process flow of providing communication information and aggregating a geospatial group index, according to one embodiment. In operation 902, communication information associated with a set of neighbors in a geo-spatial area may be automatically placed (e.g., using the group management module 110 of FIG. 1) into a group. In operation 904, the set of neighbors may be mapped (e.g., using the member management module 106 of FIG. 1) in a geo-spatial map 200 that simultaneously renders a set of pushpins representing each location of the set of neighbors to each other.

In operation 906, a moderator and users of the group may be enabled (e.g., using the group management module 110 of FIG. 1) to provide additional information on each of the set of neighbors such that data associated with the set of neighbors is accessible by those of the set of neighbors who subscribe to the group. In operation 908, a multi-modal interface may be provided (e.g., using the group management module 110 of FIG. 1) such that the communication information enables communication through a number of modes including phone, fax, SMS, email, printed mail, and/or face to face meetings between the set of neighbors (e.g., the members 104A-N of the community 102 illustrated in FIG. 1).

In operation 910, a geo-spatial group index having the group and other groups acquired through a set of internet portals may be aggregated (e.g., using the member recommendation module 108 of FIG. 1) when the moderator ports the other groups through the internet portals into a geo-spatial social network. In operation 912, an interface may be provided (e.g., using the member recommendation module 108 of FIG. 1) such that the moderator is able to limit access and editability of the multi-modal contact information.

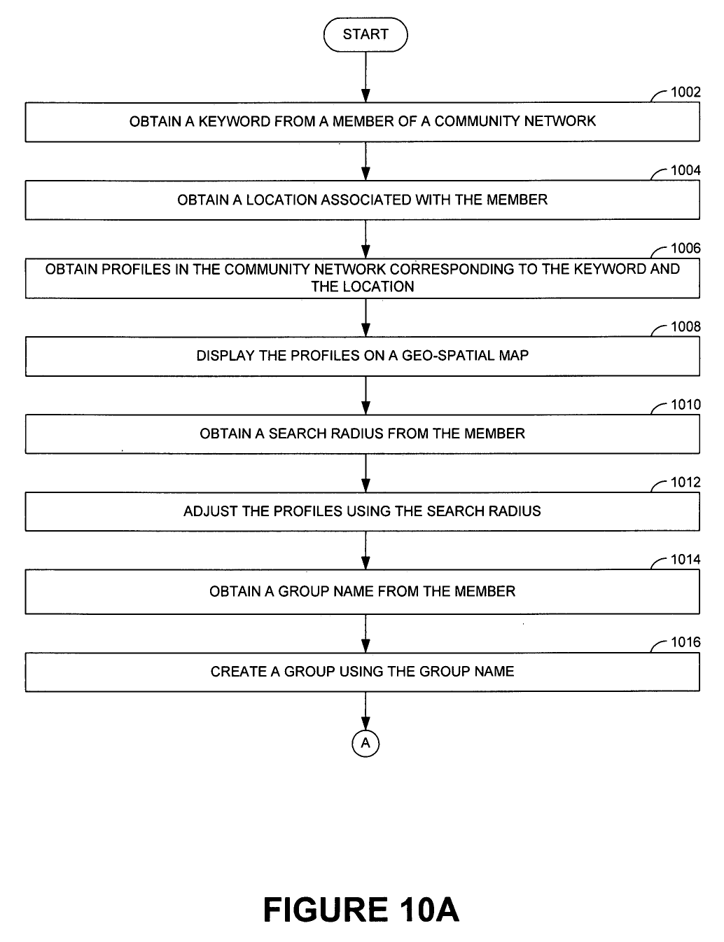

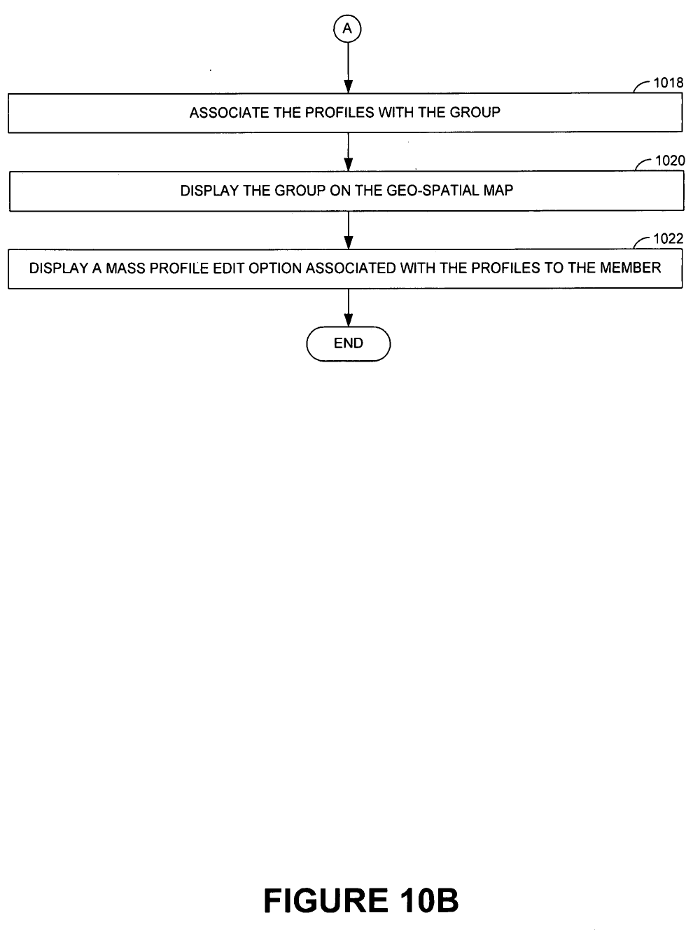

FIG. 10A is a process flow of performing a search of user profiles and creating a group using the user profiles, according to one embodiment. In operation 1002, a keyword may be obtained (e.g., using the member recommendation module 108 of FIG. 1) from a member 104 (e.g., of the members 104A-N) of a community network (e.g., the community network 100 of the community 102 illustrated in FIG. 1). In operation 1004, a location associated with the member may be obtained (e.g., using the member recommendation module 108 of FIG. 1). In operation 1006, profiles in the community network 100 corresponding to the keyword and the location may be obtained (e.g., using the member recommendation module 108 of FIG. 1).

In operation 1008, the profiles may be displayed (e.g., using the member recommendation module 108 of FIG. 1) on a geo-spatial map 200. In operation 1010, a search radius may be obtained (e.g., using the member recommendation module 108 of FIG. 1) from the member 104. In operation 1012, the profiles may be adjusted (e.g., through the member recommendation module 108 of FIG. 1) using the search radius. In operation 1014, a group name may be obtained (e.g., using the group management module 110 of FIG. 1) from the member 104. In operation 1016, a group may be created using the group name.

FIG. 10B is a continuation of the process flow of FIG. 10A, illustrating additional process, according to one embodiment. In operation 1018, the profiles may be associated with the group (e.g., using the group management module 110 of FIG. 1). In operation 1020, the group may be displayed (e.g., using the group management module 110 of FIG. 1) on the geo-spatial map 200. In operation 1022, a mass profile edit option associated with the profiles may be displayed (e.g., using the member recommendation module 108 of FIG. 1) to the member 104.

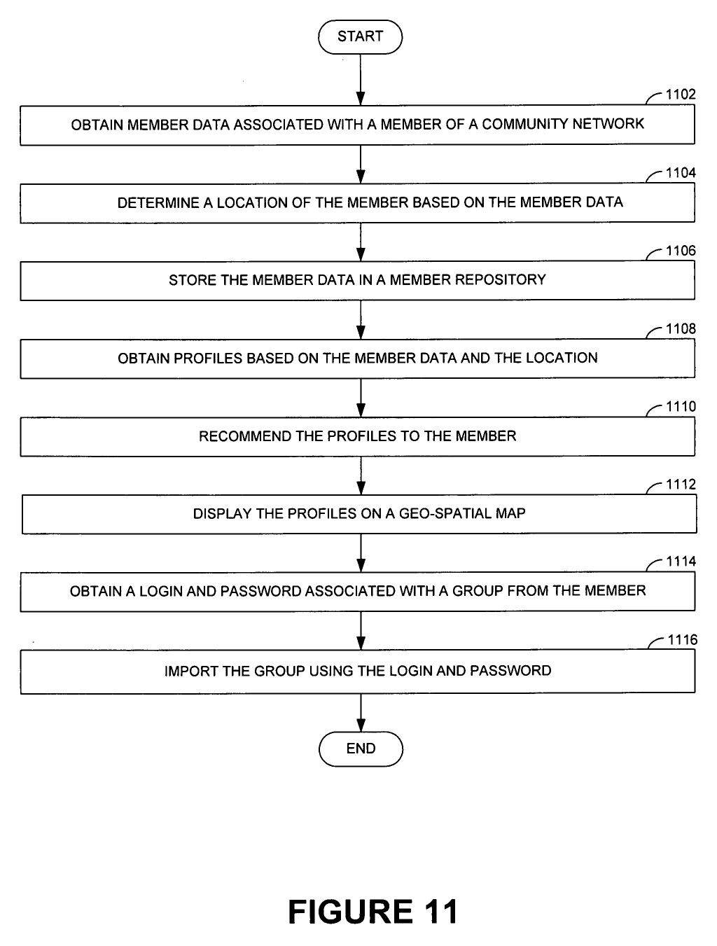

FIG. 11 is a process flow of displaying profiles and importing groups, according to one embodiment. In operation 1102, member data associated with a member 104 (e.g., of the members 104A-N) of the community network 100 may be obtained (e.g., using the member management module 106 of FIG. 1). In operation 1104, a location of the member 104 may be determined based on the member data. In operation 1106, the member data may be stored in a member repository (e.g., the member repository 114 of FIG. 1). In operation 1108, profiles may be obtained (e.g., using the member recommendation module 108 of FIG. 1) based on the member data and the location.

In operation 1110, the profiles may be recommended (e.g., using the member recommendation module 108 of FIG. 1) to the member 104. In operation 1112, the profiles may be displayed (e.g., using the member recommendation module 108 of FIG. 1) on a geo-spatial map (e.g., the geo-spatial map 200 of FIGS. 2B, 2C, and 2D). In operation 1114, a login and password associated with a group may be obtained (e.g., using the group management module 110 of FIG. 1) from the member 104. In operation 1116, the group may be imported (e.g., through the group management module 110 of FIG. 1) using the login and password.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and electrical circuits (e.g., Application Specific Integrated Circuitry (ASIC) and/or in Digital Signal Processor (DSP) circuitry). For example, the member management module 106, the member recommendation module 108, the group management module 110, and other modules of FIGS. 1-11 may be enabled using a member management circuit, a member recommendation circuit, a group management circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawing are to be regarded in an illustrative rather than a restrictive sense.

What is claimed is:

1. A method comprising:
automatically placing communication information associated with a set of neighbors in a geo-spatial area into a group;
mapping the set of neighbors in a geo-spatial map that simultaneously renders a set of pushpins representing each location of the set of neighbors to each other; and
enabling a moderator and users of the group to provide additional information on each of the set of neighbors such that data associated with the set of neighbors is accessible by those of the set of neighbors who subscribe to the group.

2. The method of claim 1, further comprising providing a multi-modal interface such that the communication information enables communication through a plurality of modes including phone, fax, SMS, email, printed mail, and face to face meetings between the set of neighbors.

3. The method of claim 2, further comprising aggregating a geo-spatial group index having the group and other groups acquired through a set of internet portals when the moderator ports the other groups through the internet portals into a geo-spatial social network.

4. The method of claim 1, wherein the data includes a visual representation of the set of pushpins simultaneously displayed in the geo-spatial map, wherein each of the set of pushpins is tied to a set of multi-modal contact information provided through the users and the moderator.

5. The method of claim 4, further comprising providing an interface such that the moderator is able to limit access and editability of the multi-modal contact information.

6. The method of claim 5, wherein the multi-modal contact information is integrated into the geo-spatial social network through a printed directory automatically transferred into the group.

7. The method of claim 6, wherein the printed directory is at least one of a school directory, a church directory, a service club directory, a student directory, a block watch directory and a neighborhood directory.

8. The method of claim 1 in a form of a machine-readable medium embodying a set of instructions that, when executed by a machine, causes the machine to perform the method of claim 1.

9. A method of performing a search, comprising:
obtaining a keyword from a member of a community network;
obtaining a location associated with the member;
obtaining a plurality of profiles in the community network corresponding to the keyword and the location; and
displaying the plurality of profiles on a geo-spatial map.

10. The method of claim 9, further comprising
obtaining a search radius from the member; and
adjusting the plurality of profiles using the search radius.

11. The method of claim 9, further comprising:
obtaining a group name from the member;
creating a group using the group name; and
associating the plurality of profiles with the group.

12. The method of claim 11, further comprising displaying the group on the geo-spatial map.

13. The method of claim 9, further comprising displaying a mass profile edit option associated with the plurality of profiles to the member.

14. The method of claim 9, wherein each of the plurality of profiles is at least one of a claimed profile and an unclaimed profile.

15. The method of claim 9, wherein each of the plurality of profiles is associated with at least one of a person, a business, and an organization.

16. A community network, comprising:
a member repository comprising a plurality of members;
a geo-spatial repository comprising a plurality of locations on a geo-spatial map;
a member management module configured to obtain member data associated with each of the plurality of members, wherein the member data comprises one of the plurality of locations; and
a member recommendation module configured to:
obtain a keyword from one of the plurality of members;
obtain a location from the one of the plurality of members;
obtain a subset of a plurality of profiles corresponding to the keyword and the location; and
display the subset of the plurality of profiles on the geo-spatial map.

17. The community network of claim 16, wherein the member recommendation module is further configured to:
obtain a search radius from the one of the plurality of members; and
adjust the subset of the plurality of profiles using the search radius.

18. The community network of claim 17, further comprising a group management module configured to:
obtain a group name from the one of the plurality of members;
create a group using the group name; and
associate the subset of the plurality of profiles with the group.

19. The community network of claim 18, wherein the group management module is further configured to display the group on the geo-spatial map.

20. The community network of claim 16, wherein the member recommendation module is further configured to display a mass profile edit option associated with the subset of the plurality of profiles to the one of the plurality of members.

21. The community network of claim 16, wherein each of the subset of the plurality of profiles is at least one of a claimed profile and an unclaimed profile.

22. The community network of claim 16, wherein each of the subset of the plurality of profiles is associated with at least one of a person, a business, and an organization.

23. A method of managing a community network, comprising:
obtaining member data associated with a member of the community network;
determining a location of the member based on the member data;
storing the member data in a member repository;
obtaining a plurality of profiles based on the member data and the location; and
recommending the plurality of profiles to the member.

24. The method of claim 23, further comprising displaying the plurality of profiles on a geo-spatial map.

25. The method of claim 24, further comprising:
obtaining a login and password associated with a group from the member; and
importing the group using the login and password.

26. The method of claim 25, wherein the group is provided using an external service.

27. The method of claim 23, wherein each of the plurality of profiles is at least one of a claimed profile and an unclaimed profile.
